(19) United States
(12) Patent Application Publication
(10) Pub. No.: US 2013/0054711 A1
(43) Pub. Date: Feb. 28, 2013

(54) METHOD AND APPARATUS FOR CLASSIFYING THE COMMUNICATION OF AN INVESTIGATED USER WITH AT LEAST ONE OTHER USER

(71) Applicants: Martin Kessner, Munchen (DE); Holger Oortmann, Herzogenaurach (DE); Martin Wimmer, Ottobrunn (DE)

(72) Inventors: Martin Kessner, Munchen (DE); Holger Oortmann, Herzogenaurach (DE); Martin Wimmer, Ottobrunn (DE)

(21) Appl. No.: 13/301,931

(22) Filed: Nov. 22, 2011

(30) Foreign Application Priority Data
Aug. 23, 2011 (EP) EP11178476

(51) Int. Cl. G06F 15/16

(52) U.S. Cl. 709/206

(57) ABSTRACT

A method and apparatus for classifying a communication of an investigated user with at least one other user has the steps of providing electronic messages exchanged by the investigated user with the at least one other user; and classifying the communication of the investigated user with the at least one other user depending on at least one calculated communication metric of the electronic messages exchanged by the investigated user with the respective at least one other user.

### CROSS-REFERENCE TO RELATED APPLICATIONS

This application claims priority to EP Patent Application No. 11178476 filed Aug. 23, 2011, the contents of which is incorporated herein by reference in its entirety.

### TECHNICAL FIELD

The invention relates to a method and apparatus for classifying the communication of an investigated user with at least one other user allowing an efficient screening and classifying for example of a large amount of email traffic.

### BACKGROUND

An organization such as a company can comprise a huge number of employees or members each receiving a plurality of electronic messages from other users within the same organization or from other users. Users will send in many cases incriminating information to other users. For example, in a financial market users might send insider information to other users and give them classified information when to buy or sell shares on the stock exchange market. Another example is corruption wherein a user might send incriminating information to another user belonging to the same or to a different organization by offering e.g. a bribe for signing a contract.

Until now it has been very difficult for investigators to find such incriminating communication. Finding, for example, an email comprising relevant information for a legal investigation is like finding the proverbial needle in the hay stack. For investigators there has been until now two options for pursuing the search. The investigator can search for the needle, i.e. the relevant information in specific spots, or he can remove as much hay as possible with the goal to make the needle stand out better until there is only a little hay left. Similarly an investigator tasked with screening and classifying a huge amount of electronic messages such as emails with the purpose to identify evidence against an investigated suspect user can quickly reduce the amount of individual messages to be cited and classified individually by identifying large chunks of electronic messages which are clearly not evident and classifying them accordingly.

A conventional way of dealing with electronic messages of an investigated user can be to identify clusters of electronic messages with certain characteristics by performing many individual searches. For example, newsletters which the investigated user has received do most likely not comprise any evidence incriminating the user. This kind of newsletters can be identified by a database search that can result in several electronic messages that the investigated user has received from a newsletter sender. The investigated user most likely did not send any emails or electronic messages to the address from which the newsletter has been transmitted to the investigated user. Accordingly, for each participant in the suspect email communication network there is a need to perform two searches or one that results in the number/set of electronic messages sent to a certain address and one that results in the number/set of electronic messages received from that address. The comparison of the number of addresses derived from the two independent searches is normally done by hand and is very labour-intensive and error-prone. Accordingly, it has been in the past very difficult to find relevant information for an investigated organization or a company with respect to criminal acts such as corruption or compliance with ethical standards.

### SUMMARY

Accordingly, there is an urgent need to provide a method and apparatus which allows to identify incriminating information of investigated users without labour-intensive manual searches.

According to an embodiment, a method for classifying a communication of an investigated user with at least one other user may comprise the steps of:

providing electronic messages exchanged by the investigated user with the at least one other user; and
classifying the communication of the investigated user with at least one other user depending on at least one calculated communication metric of the electronic messages exchanged by the user with the respective at least one other user.

In a possible embodiment of the method, the calculated communication metric comprises a ratio between the amount of electronic messages sent by the investigated user to the other user and the amount of electronic messages exchanged between the investigated user and the other user.

In a still further possible embodiment of the method, the calculated communication metric comprises an aggregation relevance index of the electronic messages exchanged between the investigated user and the other user.

In a further possible embodiment of the method, the calculated communication metric comprises a social network metric calculated for the users participating in the communication on the basis of a social data model.

In a further possible embodiment of the method, the classifying of the communication is performed for a selected extent of communication between the investigated user and the other user.

In a possible implementation the extent of communication comprises a total communication consisting of all electronic messages exchanged between the investigated user and the at least one other user.

In a further possible implementation the extent of communication comprises one or several threads of electronic messages exchanged between the investigated user and the at least one other user.

In a further possible implementation the extent of communication can comprise one or several electronic messages exchanged between the investigated user and the at least one other user.

In a further possible embodiment of the method, a communication of the investigated user is classified according to a communication class, wherein said communication class can comprise a relevant communication, a suspect communication, an evidence supporting communication and/or a not relevant communication.

In a further possible embodiment of the method, the classifying of the communication is performed depending on configurable classification criteria, wherein said configurable classification criteria can comprise

a title of the communication,
a user having initiated the communication,
an initiation time of the communication,
a termination time of the communication,
a number of messages of the communication,
a number of users participating in the communication and/or
a type of the users involved in the communication.

In a further possible embodiment of the method, the calculated communication metric is displayed as a graphical symbol on a display.

In a further possible implementation the graphical symbol can have at least one symbol parameter corresponding to the calculated communication metric.

In a further possible embodiment of the method according to the present invention a communication or a subset thereof is represented by the graphical symbol on a display which is classified by dragging the graphical symbol onto an area representing a communication class using a drag and drop operation.

In a possible embodiment of the method, the provided electronic messages exchanged between the investigated user and the at least one other user can comprise different kinds of electronic messages comprising emails, documents attached to emails, SMS messages, MMS messages, scanned letters, facsimile letters, video streams and audio streams.

In a possible embodiment of the method, the electronic messages are read offline from a storage means storing the electronic messages.

In a further possible embodiment of the method, the electronic messages are read online from a communication network connecting the investigated user with other users.

According to another embodiment, an investigation tool may comprise an investigation program having a program code performing a method for classifying a communication of an investigated user with at least one other user comprising the steps of:

providing electronic messages exchanged by said investigated user with said at least one other user; and
classifying the communication of the investigated user with the at least one other user depending on at least one calculated communication metric of the electronic messages exchanged by the user with the respective at least one other user.

According to yet another embodiment, an investigation apparatus for classifying a communication of an investigated user with at least one other user may comprise an execution engine adapted to execute an investigation tool for performing a method for classifying a communication of an investigated user with at least one other user comprising the steps of: providing electronic messages exchanged by said investigated user with said at least one other user; and classifying the communication of the investigated user with the at least one other user depending on at least one calculated communication metric of the electronic messages exchanged by the user with the respective at least one other user.

In a possible embodiment of the investigation apparatus, the investigation apparatus has access to data storage means being provided for storing electronic messages exchanged by the investigated user with the other user, wherein the stored electronic messages comprise emails, documents attached to emails, SMS messages, MMS messages, scanned letters, facsimile letters, video streams and audio streams.

In a possible embodiment of the investigation apparatus, the investigation apparatus may comprise a data interface connecting said investigation apparatus to a communication network through which electronic messages are exchanged between the investigated user and other users.

In a possible embodiment, the investigation apparatus may comprise a data interface which connects the investigation apparatus to a communication network comprising a local area network, a wide area network, the internet and/or a telephone network.

According to yet another embodiment, a communication network may comprise at least one investigation apparatus for classifying a communication of an investigated user with said at least one other user,

wherein said investigation apparatus comprises an execution unit adapted to execute an investigation tool which classifies a communication of an investigated user with at least one other user by
providing electronic messages exchanged by the investigated user with at least one other user; and by
classifying the communication of the investigated user with the at least one other user depending on at least one calculated communication metric of the electronic messages exchanged by the user with the respective at least one other user.

### BRIEF DESCRIPTION OF THE DRAWINGS

In the following possible embodiments of the method and apparatus for classifying a communication of an investigated user with at least one other user are described with reference to the enclosed figures.

FIG. 1 shows a block diagram for illustrating a possible embodiment of an investigation apparatus for classifying a communication of an investigated user with at least one other user;

FIG. 2 shows a simple flow chart of a possible embodiment of a method for classifying a communication of an investigated user with at least one other user;

FIG. 3 shows an exemplary mask of a mail browser employing an investigation software tool according to a possible implementation;

FIG. 4 shows a further exemplary mask of a mail browser employing an investigation software tool according to the implementation;

FIG. 5 shows a further exemplary mask of a mail browser employing an investigation tool according to a possible implementation;

FIG. 6 shows diagrams for illustrating a possible implementation of an investigation software tool;

FIG. 7 shows a possible configuration scheme as employed by the method in a specific implementation.

FIG. 8 illustrates an operation of getting meta information of a communication partner of an investigated user

### DETAILED DESCRIPTION

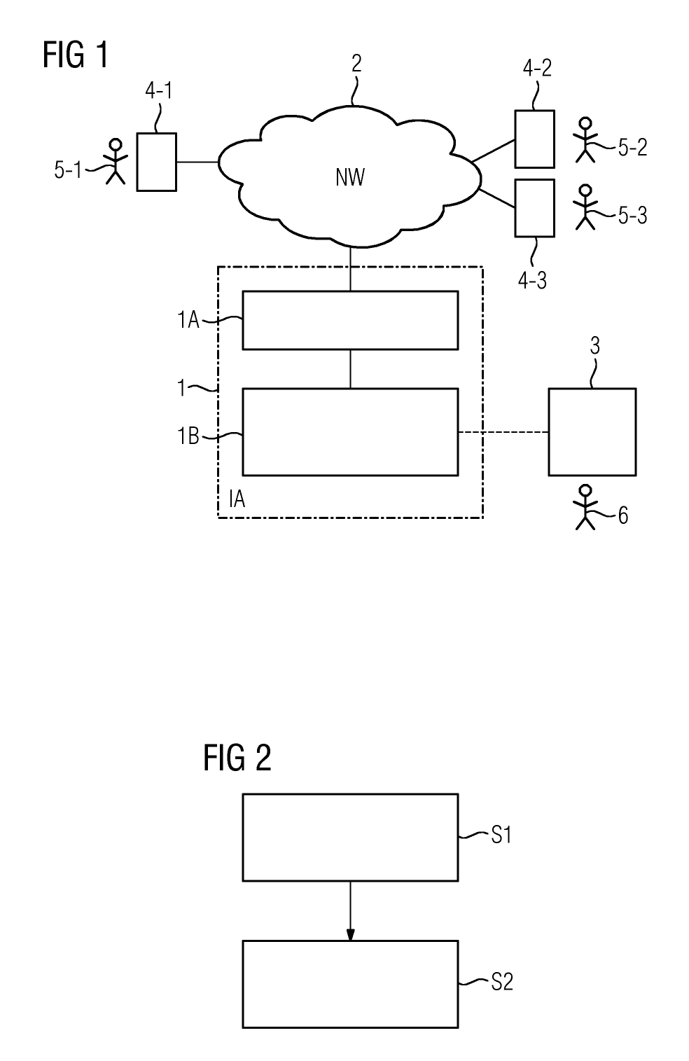

As can be seen in FIG. 1 an investigation apparatus 1 according to an embodiment can be connected to a communication network 2 via interface unit 1A of the investigation apparatus 1. The investigation apparatus 1 further can comprise an execution unit 1B adapted to execute an investigation tool which classifies a communication of an investigated user with at least one other user. As shown in the embodiment of FIG. 1 the investigation apparatus 1 has further access to a data storage 3. The data storage 3 can be provided for storing electronic messages exchanged by an investigated user 5-1 with other users 5-2, 5-3. To the communication network 2 a plurality of terminals 4-i can be connected. In the simple example of FIG. 1 three terminals 4-1, 4-2, 4-3 are connected to the communication network 2. Each communication terminal 4-i can be operated by a user 5-i as shown in FIG. 1. In the simple example of FIG. 1 the first user 5-1 might be an investigated user who does exchange electronic messages with other users 5-2, 5-3, for example users belonging to the same organization or company. In the implementation shown in FIG. 1 the investigation apparatus 1 is connected online to the communication network 2 to monitor electronic messages M exchanged from the terminal 4-1 of the investigated user 5-1 with the terminals 4-2, 4-3 of the other users. In an alternative embodiment the investigation might be performed offline wherein the investigation apparatus 1 evaluates electronic messages M stored in a data storage such as the data storage 3 shown in FIG. 1. For example, the data storage 3 might be a hard disc taken from the terminal 4-1 of the investigated user 5-1 storing a plurality of exchanged electronic messages of the investigated user 5-1. In a further embodiment the investigation apparatus 1 can copy a data content of a data storage within the terminal 4-1 and store a copy of the communication messages M in the data storage 3 for further investigation. In a further embodiment the investigation apparatus 1 can be integrated in the terminal 4-1 of the investigated user 5-1. In a further embodiment the investigation apparatus 1 can comprise a user interface for the investigator 6 as illustrated in FIG. 1. In a further embodiment the investigation apparatus is connected with a plurality of terminals that each comprise the user interface for an investigator. The investigator 6 might be a person performing a legal investigation seeking evidence against an investigated user such as the user 5-1.

The communication network 2 shown in FIG. 1 can be any kind of communication network, in particular a data network or a telephone network. Furthermore, the communication network 2 can be provided for transporting any kinds of electronic messages including emails, documents attached to emails, SMS messages, MMS messages, scanned letters, facsimile letters, video streams and/or audio streams. The communication network 2 can be a wired or a wireless network. The transport of the electronic messages can be via an optical or electronic data transmission medium. The investigation apparatus 1 as shown in FIG. 1 comprises the execution unit 1A which can comprise one or several microprocessors for executing an investigation software tool which classifies a communication of the investigated user 5-1 with at least one other user such as the users 5-2, 5-3 shown in FIG. 1. The investigation apparatus 1 has access to the data storage 3 which can be provided for storing electronic messages M exchanged by the investigated user 5-1 with the other users. The investigation software tool executed by the execution unit 1B comprises a program code for performing a method for classifying a communication of an investigated user with the at least one other user. A flow chart of a possible implementation of such a method is shown in FIG. 2.

In a first step S1 the electronic messages M exchanged by the investigated user such as user 5-1 with the at least one other users such as the users 5-2, 5-3 are provided. The electronic messages can be read in a possible implementation from the data storage means 3 such a hard disc of the investigated user 5-1. In an alternative embodiment the electronic messages are read online from the communication taking place via the communication network 2. In a possible embodiment the terminal 4-1 of the investigated user 5-1 is configured by the investigator 6 such that all electronic messages M submitted by the terminal 4-1 are automatically copied to the investigation apparatus 1 and that all electronic messages M received by the terminal 4-1 are also copied to the investigation apparatus 1. In this embodiment an online observation and monitoring of the investigated user 5-1 is possible. In an alternative embodiment an offline investigation takes place by evaluating all electronic messages read from a data storage 3 of the investigated user 5-1. In an alternative embodiment an offline investigation takes place by evaluating all electronic messages read from a data storage 3 that hosts a database combining the content of multiple hard discs, data CDs or DVDs or other means of electronic storage. The multiple storage devices can come from multiple investigated users.

In a further step S2 of the method shown in FIG. 2 a communication of the investigated user 5-1 with the at least one other user is classified depending on at least one calculated communication metric of the electronic messages M exchanged by the investigated user with the respective at least one other user. In a possible embodiment the calculated communication metric can comprise a ratio between the amount of electronic messages sent by the investigated user 5-1 to the other user and the amount of electronic messages exchanged between the investigated user 5-1 with the respective other user. The calculated communication metric can comprise an aggregated relevance index of the electronic messages exchanged between the investigated user 5-1 and the other user. In a further embodiment the calculated communication metric can comprise a social network metric calculated for the users participating in a communication on the basis of a social data model.

In a possible embodiment a classification of the communication is performed for a selected extent of communication between the investigated user and the other user. This extent of communication can comprise a total communication consisting of all electronic messages M exchanged between the investigated user 5-1 and the at least one other user. In a further possible implementation the extent of communication can also comprise one or several threads of electronic messages M exchanged between the investigated user 5-1 and the at least one other user. It is further possible that the extent of communication comprises only one or several electronic messages M exchanged between the investigated user 5-1 and the at least one other user.

The communication of the investigated user such as the investigated user 5-1 shown in FIG. 1 can be classified according to a communication class comprising, for example, a relevant communication, a suspect communication, an evidence supporting communication and/or a not relevant communication. Further, the classification of the communication can be performed by the execution unit 1B depending on configurable classification criteria. These classification criteria can comprise a title of the communication, a title of the respective thread or a title of the group of investigated messages. Further, a possible classification criterion can be the user which has initiated the communication. For example, communication initiated by the investigated user 5-1 might be more interesting than communication initiated by other users. A further possible classification criterion can be the initiation time of the communication. If the investigated act has, for example, taken place at a specific date a communication taking place on this date and the following period may be more relevant than a communication taking place several weeks later or several months before the investigated act. A further possible classification criterion is the termination time of the communication. A further possible configurable classification criterion can be the number of electronic messages of the respective communication. In a still further possible embodiment the number of users participating in the communication can be used as a configurable classification criterion by the execution unit 1B of the investigation apparatus 1. For performing a criminal act the number of participating users is normally very limited. In contrast, a newsletter having no incriminating content is normally sent to a large number of users. A further possible configurable classification criterion can be a type of the users involved in the communication. For example, it may be relevant whether the users are users of the same organizations or company or external users. Further, it might be relevant to what hierarchy level in the organization the users participating in the communication do belong.

It might be of importance whether the other users are also suspect users and are also under investigation. For example, if the user 5-2 shown in FIG. 1 is also a suspect user and investigated by the investigator 6, a communication taking place between the first investigated user 5-1 and the other investigated user 5-1 is of importance and highly relevant for the investigation.

In a possible implementation investigation apparatus 1 can comprise a graphical user interface GUI for the investigator 6 including a display, wherein a calculated communication metric is displayed as a graphical symbol. The graphical symbol may be, for example, a circle or a bubble. The graphical symbol does have at least one symbol parameter corresponding to the calculated communication metric. This parameter can be a diameter or a radius of a displayed circle or bubble.

In a specific implementation the communication or a subset thereof being represented by a graphical symbol shown on the display of the investigation apparatus 1 can be classified by dragging the graphical symbol onto an area representing a classification class by employing a drag and drop operation. Alternatively, a selected communication can be classified into a classification class by pressing a button representing a classification class, by a corresponding keyboard shortcut or by selecting a corresponding menu entry.

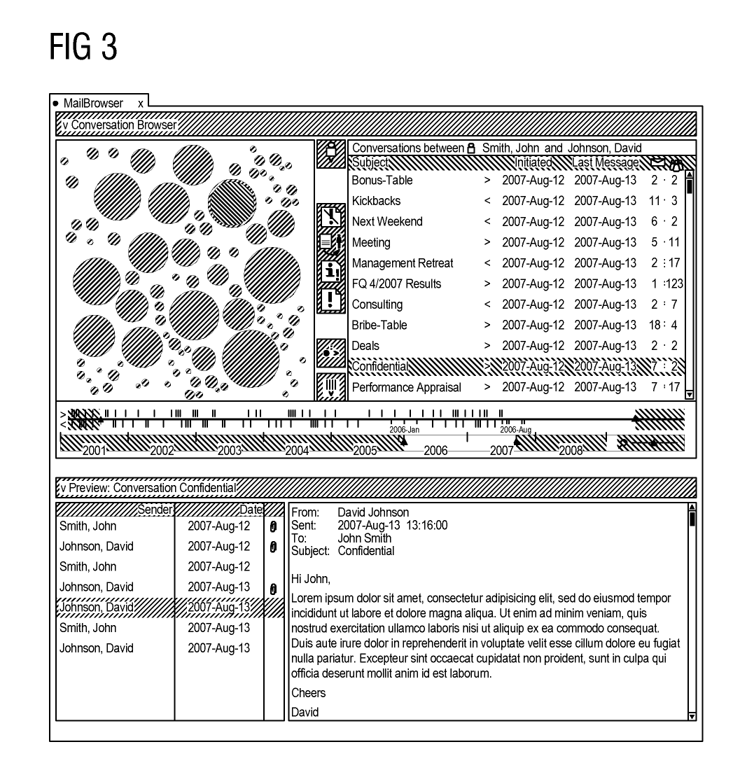

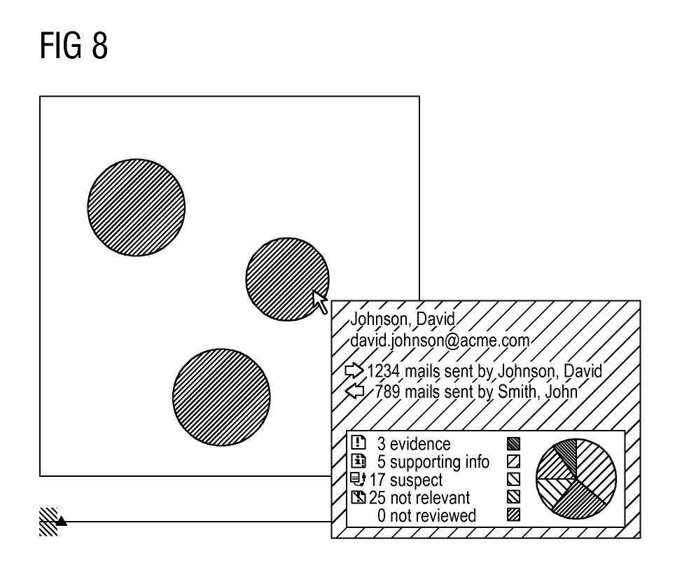

FIG. 3 shows an exemplary mask of a mail browser employing an investigation software tool according to various embodiments. As can be seen in FIG. 2 the mask displayed to the investigator 6 can comprise different areas. A communication partner of the suspected investigated user 5-1 can be represented by a row in a table or by an element such as a bubble or circle in a diagram as shown in FIG. 3. The table row or bubble gives information on the total amount or number of electronic messages M sent by the respective investigated user to the other user and also information on the number or amount of electronic messages received from the other user and sent to the other user. In a specific implementation the size of an outer bubble can represent the total number of electronic messages exchanged between the investigated user 5-1 and another user and the size of an inner bubble can represent the number of electronic messages sent by the investigated user 5-1 to the address of the other user. The search can be restricted to a pre-defined time frame. A table or a bubble diagram can contain additional information such as whether the communication partner has an internal or external relation with the suspected user of the organization. This might be identified by the domain name of the respective email address. In an implementation using a bubble diagram a tool tip for each bubble can provide the numbers of electronic messages exchanged, the number of electronic messages sent and the number of electronic messages received by the investigated user 5-1 as illustrated by FIG. 8. By placing a mouse over the respective bubble within the upper left first area of the mask shown in FIG. 3 the investigator 6 might get this information. A specific example of a bubble in the first area concerns a communication partner 5-i with the name of David Johnson. By placing the mouse on the bubble the electronic messages exchanged between the investigated person John Smith with his communication partner Mr. David Johnson are displayed to the investigator 6. The size of the bubble in the first area illustrates the amount of electronic messages M exchanged between the investigated user 5-1 and his communication partners.

In a second area of the shown user interface of FIG. 3 a table can reveal all communication threads or topics in a communication between the investigated user 5-1 and the communication partner that is represented by the table row or the bubble. This thread can be identified by a subject such as next weekend or Consulting or confidential. The table can contain additional information such as the title of the conversation thread or topic. Further, it is shown to the investigator 6 when the communication has been initiated and by whom. As an additional information the data of the last message of the conversation thread or topic can also be displayed. Further, there can be an information how many communication partners did participate in the conversation thread or topic. As an additional information it can be displayed how many communication partners have been involved in the conversation thread or topic and whether the communication partners have been internal or external communication partners.

For example, the communication of the investigated user Mr. John Smith with the subject confidential has been initiated by the investigated user Mr. Smith as illustrated by an arrow pointing to the right. This communication has been initiated on Aug. 12, 2007 and terminated on Aug. 13, 2007. The amount of electronic messages M within this communication thread comprises seven communication messages M. Two users have participated in this confidential communication thread. Dots with colours can indicate whether the participating users have been internal or external users. In the given example of FIG. 3 the communication thread confidential is interesting to an investigator, for example, because the number of participating communication partners is low.

The subject also hints to an interesting communication thread. For example, also a thread such as Bribe table is also of importance when investigating corruption in the organization. In contrast, a communication thread with the subject performance appraisal with 17 users participating in the communication thread is most likely not interesting because of the high number of participating users posing a high risk to the investigated user 5-1 when indicating incriminating information in such a thread. A communication or a subset thereof represented by a graphical symbol such as bubble can be classified by the investigator 6 by dragging the graphical symbol onto an area representing a communication class. For example, the investigator 6 might drag the bubble of the communication partner David Johnson in a drag and drop operation to a classifying button such as the exclamation mark shown in FIG. 3 classifying it as potentially highly relevant evidence. Further, other classification buttons may indicate that the dragged information comprises a not relevant communication, a suspect communication or an evidence supporting communication. The classification buttons for drag and drop operation classification as shown in FIG. 2 are only exemplary. All kinds of classification buttons and classification classes can be provided in other embodiments.

In the embodiment shown in FIG. 3 in a third area of the user interface all electronic messages M of the selected conversation or thread or selected topic are displayed. For example, the investigator 6 has selected the conversation with the subject confidential comprising certain electronic messages exchanged between the investigated user Smith and his communication partner David Johnson. Each message M can be represented by a header information like sender, date and presence of attachments. A further field can represent the message document itself. The investigator 6 can select a specific electronic message M within the communication thread confidential and read its content as shown in FIG. 3. In the example, the electronic message M comprises a text in Latin, so that the investigator 6 has to consult an expert to understand its meaning. In a further possible embodiment the individual messages can also be displayed as cards that include header information and a message body in one display area.

In a possible embodiment a mass tagging mechanism can allow the investigator 6 to classify large chunks of electronic messages M at once, for example, an entire bubble or table row from the first user interface area or an entire conversation of the second interface area. This can be done by a dragging a table row or a bubble on one or several tag buttons by selecting a bubble or table row and pressing the button. To support the work flow of classifying the searches can be configured in such a manner that only untagged (unclassified) electronic messages are represented in the bubbles or tables of the first user interface area of the mask shown in FIG. 3. The dragging of a bubble or table row on a tag or classification button does reduce the amount of bubbles/rows so that the investigating user 6 can monitor his progress of investigation work.

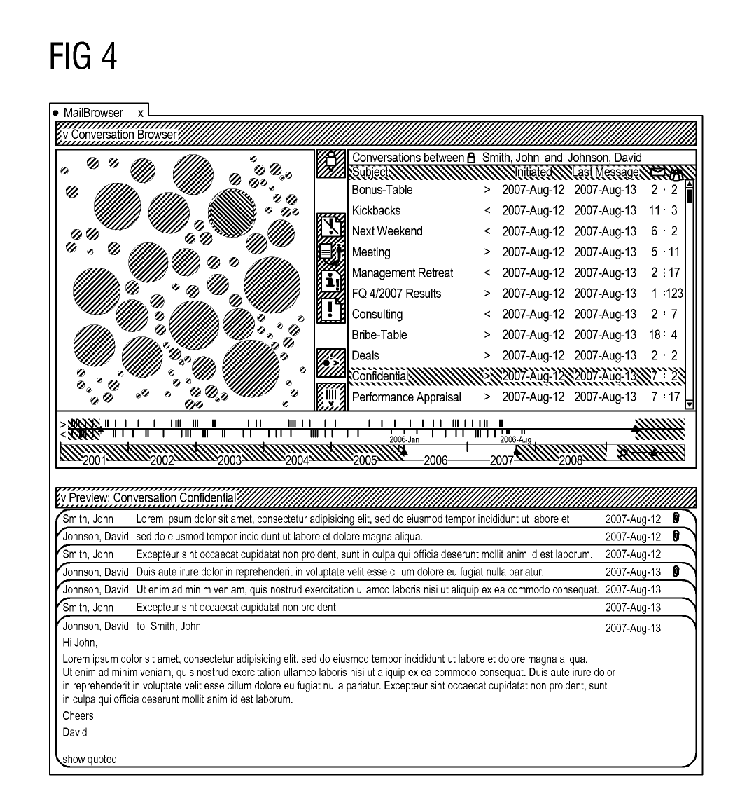

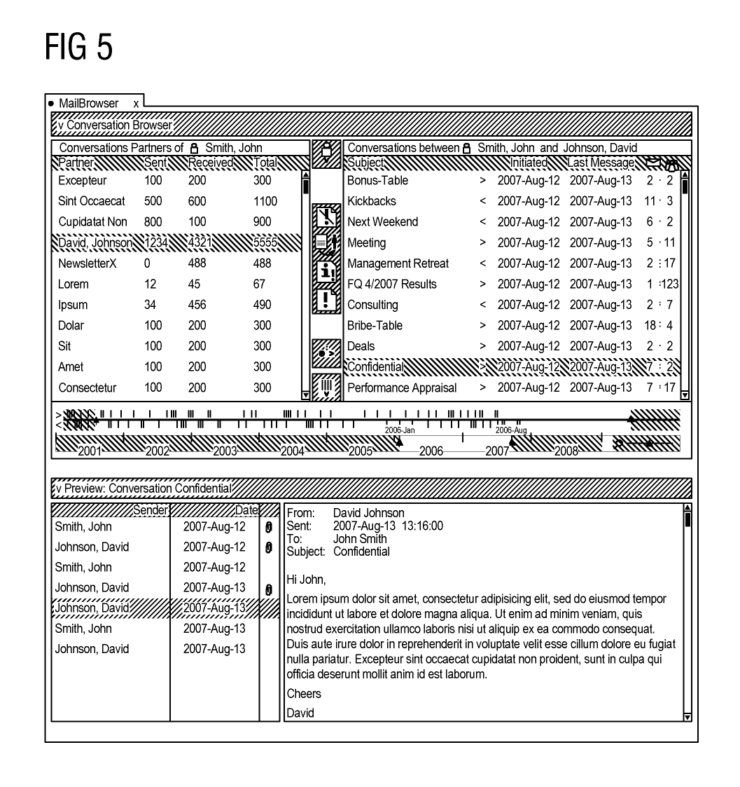

FIG. 4 shows a further exemplary mask which can be used by an investigation tool according to various embodiments. Each bubble shown in FIG. 4 can represent the email or electronic message traffic between the selected investigated user 5-1 (John Smith) and one of his conversation partners. The bubble size can indicate the mail volume, i.e. the number of electronic messages M exchanged. The bubble colour can further indicate whether the conversation partner is an investigated person himself, an internal member of the organization or an external person. The bubbles can further indicate the proportion of incoming versus outgoing electronic messages. The bubble colour saturation can further indicate in a specific implementation an aggregated relevance index of the respective mail traffic. In a further embodiment the diagram can be configured, for example using a button that opens a configuration dialogue.

The shown mask of FIGS. 3 and 4 can also provided in a specific implementation with a time line of outgoing electronic messages and incoming electronic messages, for example messages going out from the investigated person Mr. Smith to his communication partner Mr. David Johnson and messages which are received by the investigated person Mr. John Smith from his conversation partner Mr. David Johnson.

The time line shows the email traffic of the investigated person over time, i.e. the outgoing versus the incoming electronic messages. The timeline can be used to restrict the timeframe of the current analysis. Only messages in the specified timeframe will be represented in the other user interface areas.

In the second area, if no bubble has been selected in the first area all conversations with other communication partners are listed. After selection of a bubble, i.e. a communication with a specific conversation partner all conversations or threads with the selected communication partner are illustrated in the second area of the mask as shown in FIG. 4.

The investigator 6 has the option to drag bubbles to the classification buttons for classifying the communication. It is possible for the investigator 6 to classify a thread such as the thread confidential by dragging the respective thread to a classification button. Likewise, individual messages can be classified. The selected conversation is directly displayed to the investigator 6 as shown in FIG. 4.

FIG. 5 shows a further exemplary display of a mail browser employing an investigation tool according to various embodiments. In the shown example the first area of the display mask not bubbles are shown but a table indicating the number of electronic messages sent by the investigated user to his communication partner and received from the respective communication partner. Further, the total amount or number of messages M exchanged with the respective other communication partner is displayed as well. For example, if the investigated user John Smith has sent 1234 electronic messages M to his communication partner Mr. David Johnson and has received from the communication partner 4,321 electronic messages, a total of 5,555 electronic messages M have been exchanged between the investigated person John Smith and the communication partner David Johnson over time. In a possible specific implementation at least one communication metric is calculated as a ratio between the amount of the electronic messages sent by the investigated user to the other user and the amount of electronic messages exchanged between the investigated user and the other user. For example, as one communication metric of the communication between the investigated person John Smith and his communication partner David Johnson can be calculated as Ratio-1=1234:5555=0.2221422. The use of other calculated communication metrics is also possible. A possible metric is for instance the ratio R1 between the number of sent communication messages and the number of received communication messages. A further possible communication metric is the ratio R2 between received communication messages and sent communication messages. For example, a newsletter has a communication metric R2 being almost infinite. Any kind of electronic messages or communication threads might be filtered automatically from the pool of messages to be investigated depending on one or several calculated metrics. In a possible embodiment the investigator 6 can pre-configure communication metrics according to the investigation needs. Further, the investigator 6 can set threshold values for filtering the electronic messages. For example, the investigator 6 might configure as a communication metric a ratio R2 between the received electronic messages and the sent electronic messages within a communication thread. Further, it can indicate a threshold value to filter all conversations having a metric exceeding a preconfigured threshold value. For example, if the ratio R2 between the received electronic messages and the sent electronic messages surpasses a predetermined threshold value TH of i.e. 1,000, (R2>TH) it is most likely that the conversation thread relates to a newsletter or a similar kind of message and is most likely not interesting for the investigation. In a possible embodiment the investigator 6 might pre-configure a more complicated investigation metric depending on different factors or parameters. A factor might, for example, be whether the conversation was initiated by the investigated person or by a third person. A further possible factor or parameter for the preconfigured communication metric can be, for example, the number of participants or users participating in the communication thread.

In a possible embodiment the investigator 6 can choose a plurality of predefined communication metrics for different kind of investigation processes. In a further possible implementation the investigator 6 can also input key words or tags for finding specific conversation threads comparing the tags with conversation titles like subject. A possible key word or tag can be, for example, confidential. Matching of a tag can also form a parameter within a complex communication metric depending on one or more investigation parameters. In general, the communication metric can be expressed as a metric function MF (p1, p2, p3, p4 . . . pₙ) wherein investigation parameters p can be selected or configured by the investigator 6. In a specific embodiment a first parameter p1 can be the number of electronic messages M exchanged between the investigated user and another user and a second parameter p2 can be the amount of electronic messages sent by the investigated user. A complex communication metrics comprising a higher number of communication parameters can be defined by the investigator 6. In this way the investigator 6 can perform the classification of the communication by means of a communication metric which can be tuned and adjusted according to the needs of the investigation.

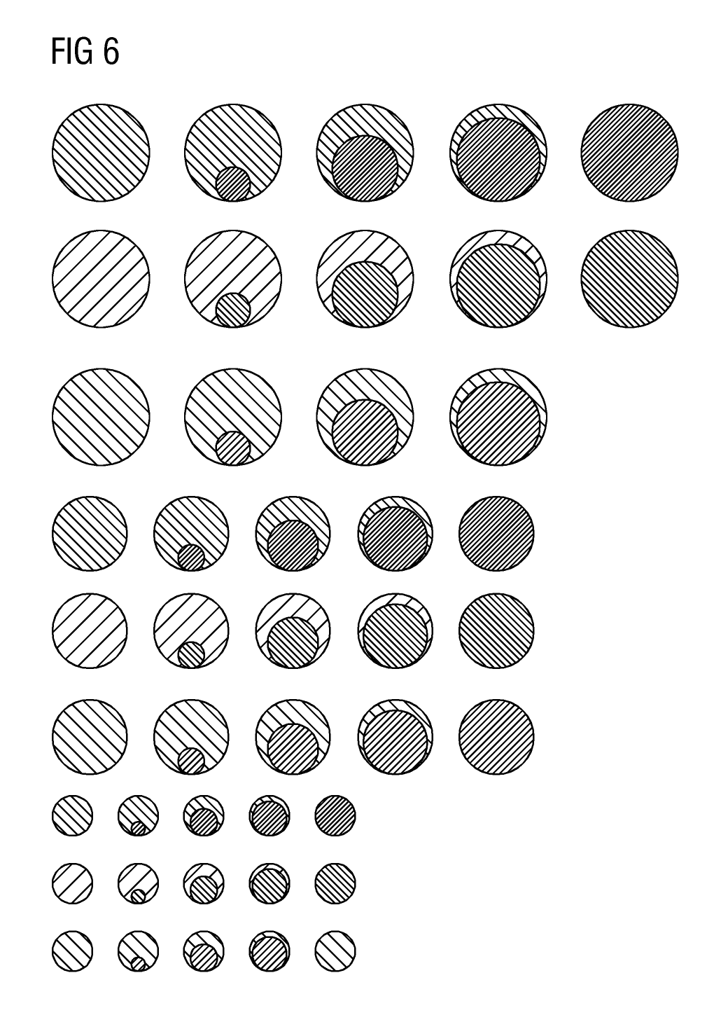

FIG. 6 shows diagrams for illustrating a specific implementation for classifying a communication of an investigated user with other users. In this simple implementation the circles represent a communication of the investigated user with another user wherein an outer bubble indicates the total number of electronic messages M exchanged with the other user and an inner bubble indicates the number of electronic messages sent by the respective user. The outer lighter coloured bubbles represent a total mail volume wherein the size of the inner darker coloured bubbles can represent the number of outgoing messages. For example, when the investigated user 5-1 has received a lot of emails from an external communication partner but has not sent any mails to them it is most likely a kind of newsletter.

If the bubble size is big the investigated person has a lot of email traffic with the other user and if the inner circle is at the same time of a considerable size both communication partners have actively taken part in the correspondence so that this might be a relevant communication for the investigation. The colour of the bubbles can give additional information.

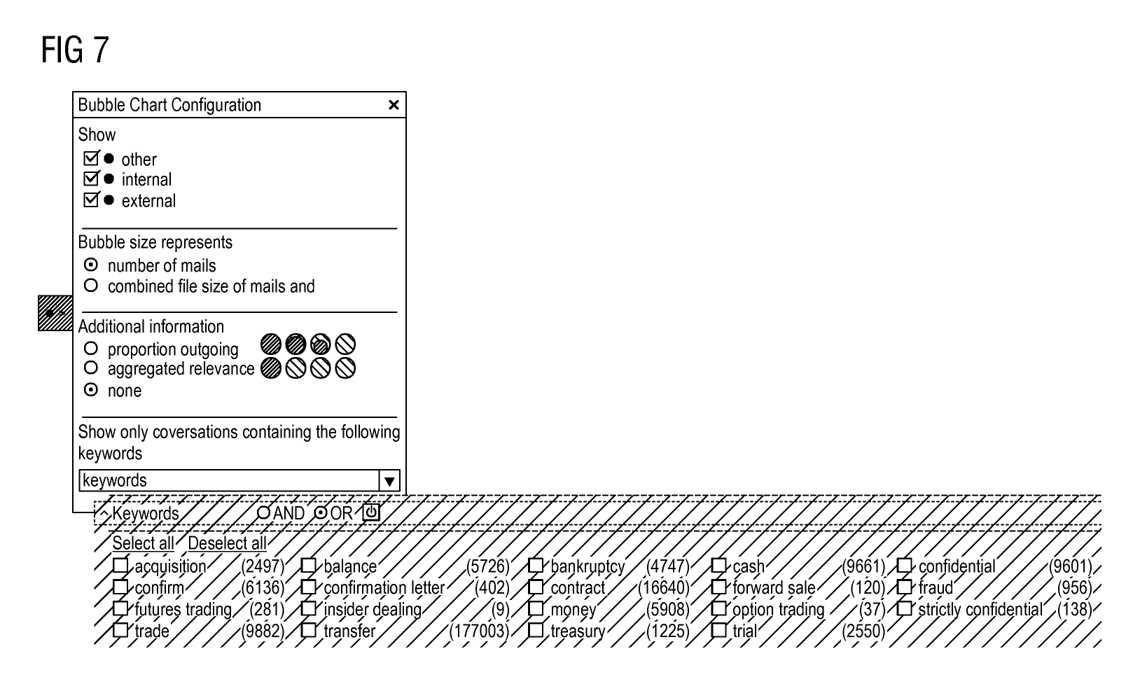

FIG. 7 shows a possible implementation of a mask for performing a configuration of the investigation tool.

The method and apparatus for classifying a communication of an investigated user can be used in a wide range of applications. For example, it can be used within a company investigating employees being suspect of corruption or non-compliance with ethical values of the company. A further possible application is for financial markets to avoid insider deals of users. A further application, in particular when monitoring electronic messages online is to combat crime or terrorism. The investigation tool according to various embodiments is a powerful software tool that can be used by the investigators or the police to find incriminating material for legal prosecution of investigated users. The investigation apparatus 1 as shown in FIG. 1 being connected to a communication network 2 can also be a mobile device. The investigation apparatus 1 according to various embodiments can be adapted to screen any kinds of electronic messages or data, in particular emails and documents attached to emails. The documents can comprise text documents but also audio or video files. In a possible implementation the investigation apparatus can also perform a matching between data of the investigated electronic messages and data input by the investigator 6 by means of a user interface of the investigation apparatus 1. In an embodiment the classification is performed offline. In an alternative embodiment classification is performed online. In a possible implementation the classification can be even performed in real time. The investigator 6 can during classification of incriminating material against the suspect investigated user trigger in a possible embodiment actions or operations against the investigated user. In a further possible embodiment the investigation apparatus 1 shown in FIG. 1 can be connected via a safe communication link to a server such as a server of a police organization or the like. The documents of a communication being classified as relevant can be forwarded automatically to such a server and stored there for the following legal prosecution. The investigation tool according to various embodiments is not restricted to investigations of a person suspect to a criminal act but also for quality improvement, for instance, in a service centre such as a call centre. In this application the investigator 6 can monitor whether the investigated employee provides a desired performance, for example, when responding to inquiries of costumers. In a further embodiment the method can be used as a service quality control software tool. The investigation tool can, for example, be used for finding employees surfing in the internet without relevance to their daily work. According to various embodiments, an apparatus and a method for efficient screening and classifying of a large amount of electronic messages or data traffic can be provided. The method and apparatus can be widely used for a wide range of applications in an offline or online operation mode.

What is claimed is:

1. A method for classifying a communication of an investigated user with at least one other user comprising the steps of:
(a) providing electronic messages exchanged by said investigated user with said at least one other user; and
(b) classifying the communication of the investigated user with the at least one other user depending on at least one calculated communication metric of the electronic messages exchanged by the investigated user with the respective at least one other user.

2. The method according to claim 1, wherein said calculated communication metric comprises a ratio between the amount of electronic messages sent by the investigated user to the other user and the amount of electronic messages exchanged between the investigated user and the other user.

3. The method according to claim 1, wherein said calculated communication metric comprises an aggregation relevance index of the electronic messages exchanged between the investigated user and the other user.

4. The method according to claim 1, wherein said calculated communication metric comprises a social network metric calculated for the users participating in the communication on the basis of a social data model.

5. The method according to claim 1, wherein the classifying of the communication is performed for a selected extent of communication between the investigated user and the other user, wherein said extent of communication comprises:
a total communication consisting of all electronic messages exchanged between the investigated user and the at least one other user;
one or several threads of electronic messages exchanged between the investigated user and the at least one other user; and
one or several electronic messages exchanged between the investigated user and the at least one other user.

6. The method according to claim 1, wherein said communication of the investigated user is classified according to a communication class comprising:
a relevant communication,
a suspect communication,
an evidence supporting communication and
a not relevant communication.

7. The method according to claim 1, wherein the classifying of the communication is performed depending on configurable classification criteria comprising:
a title of the communication,
a user having initiated the communication,
an initiation time of the communication,
a termination time of the communication,
a number of messages of the communication,
a number of users participating in the communication and
a type of the users involved in the communication.

8. The method according to claim 1, wherein said calculated communication metric is displayed as a graphical symbol on a display,
said graphical symbol having at least one symbol parameter corresponding to the calculated communication metric.

9. The method according to claim 8, wherein the communication or a subset thereof represented by said graphical symbol on a display is classified by dragging the graphical symbol onto an area representing a communication class using a drag and drop operation.

10. The method according to claim 1, wherein the provided electronic messages exchanged between the investigated user and the at least one other user comprise:
emails, documents attached to emails, SMS messages, MMS messages, scanned letters, facsimile letters, video streams and audio streams.

11. The method according to claim 1, wherein the electronic messages are read offline from a storage means storing the electronic messages or online from a communication network connecting the investigated user with other users.

12. An investigation tool comprising a computer readable medium storing an investigation program having a program code which when executed on a computer performs the steps of:
(a) providing electronic messages exchanged by an investigated user with at least one other user; and
(b) classifying the communication of the investigated user with the at least one other user depending on at least one calculated communication metric of the electronic messages exchanged by the investigated user with the respective at least one other user.

13. An investigation apparatus for classifying a communication of an investigated user with at least one other user comprising an execution engine adapted to execute an investigation tool by
(a) providing electronic messages exchanged by said investigated user with said at least one other user; and
(b) classifying the communication of the investigated user with the at least one other user depending on at least one calculated communication metric of the electronic messages exchanged by the investigated user with the respective at least one other user.

14. The investigation apparatus according to claim 13, wherein the investigation apparatus has access to data storage means being provided for storing electronic messages exchanged by the investigated user with the other users,
wherein said stored electronic messages comprise:
emails, documents attached to emails, SMS messages, MMS messages, scanned letters, facsimile letters, video streams and audio streams.

15. The investigation apparatus according to claim 13, wherein said investigation apparatus comprises a data interface connecting said investigation apparatus to a communication network through which electronic messages are exchanged between the investigated user and other users,
wherein said communication network comprises a local area network, a telephone network and the internet.

16. The investigation apparatus according to claim 13, wherein said calculated communication metric comprises a ratio between the amount of electronic messages sent by the investigated user to the other user and the amount of electronic messages exchanged between the investigated user and the other user.

17. The investigation apparatus according to claim 13, wherein said calculated communication metric comprises an aggregation relevance index of the electronic messages exchanged between the investigated user and the other user.

18. The investigation apparatus according to claim 13, wherein said calculated communication metric comprises a social network metric calculated for the users participating in the communication on the basis of a social data model.

19. The investigation apparatus according to claim 13, wherein the investigation apparatus performs the classifying of the communication for a selected extent of communication between the investigated user and the other user, wherein said extent of communication comprises:
a total communication consisting of all electronic messages exchanged between the investigated user and the at least one other user;
one or several threads of electronic messages exchanged between the investigated user and the at least one other user; and
one or several electronic messages exchanged between the investigated user and the at least one other user.

20. A communication network comprising at least one investigation apparatus for classifying a communication of an investigated user with said at least one other user wherein said investigation apparatus comprises an execution unit adapted to execute an investigation tool which classifies a communication of an investigated user with at least one other user by:
providing electronic messages exchanged by the investigated user with at least one other user and
classifying the communication of the investigated user with at least one other user depending on at least one calculated communication metric of the electronic messages exchanged by the user with the respective at least one other user.
